(19) United States
(12) Patent Application Publication
(10) Pub. No.: US 2013/0097870 A1
(43) Pub. Date: Apr. 25, 2013

(54) RECIPROCATING ELECTRIC SHAVER

(71) Applicants: Yoichi Takaoka, Shiga (JP); Fumio Taniguchi, Shiga (JP); Yasuo Ibuki, Shiga (JP)

(72) Inventors: Yoichi Takaoka, Shiga (JP); Fumio Taniguchi, Shiga (JP); Yasuo Ibuki, Shiga (JP)

(73) Assignee: PANASONIC CORPORATION, Osaka (JP)

(21) Appl. No.: 13/808,065

(22) PCT Filed: Jun. 14, 2011
(86) PCT No.: PCT/JP2011/063550

§ 371 Date: Jan. 2, 2013

(30) Foreign Application Priority Data
Jul. 8, 2010 (JP) 2010-156146

(51) Int. Cl. B26B 19/28

(52) U.S. Cl. CPC B26B 19/28
USPC 30/42

(57) ABSTRACT

A reciprocating electric shaver includes: a pair of drive blocks 200, 210 each including: a driver 130 (140) for driving a blade 54; a balance adjusting portion interlocked with the driver 130 (140). The drivers 130, 140 of the pair of the drive blocks 200, 210 make reciprocating movements in opposite phases relative to each other. With respect to an axis of moments attributable to the reciprocating movements of the drivers 130, 140, the balance adjusting portions 220 (230) and the drivers 130 (140) in the respective drive blocks 200 (210) are positioned opposite to each other so as to suppress the moments.

### TECHNICAL FIELD

The present invention relates to a reciprocating electric shaver.

### BACKGROUND ART

A shaver conventionally known as a reciprocating electric shaver comprises a converting mechanism for converting a rotation of a rotational motor to a reciprocating movement, where the converting mechanism allows a driver (to which an inner blade is mounted) to make the reciprocating movement and a balancer making a reciprocating movement in a phase shifted 180° is provided below the driver (for example, refer to PTL 1).

The PTL 1 suppresses a vibration in the reciprocating direction of the driver by reciprocating the driver and the balancer in opposite phases.

Then, when two drivers to which the inner blades are mounted are provided in parallel, it is conceivable that the vibration of the drivers in the reciprocating directions is suppressed by reciprocating the respective drivers in opposite phases relative to each other.

### CITATION LIST

### Patent Literature

[PTL 1] JP 2004-016524 A
[PTL 2] JP 07-250978 A
[PTL 3] JP 10-179956 A

### SUMMARY OF INVENTION

### Technical Problem

However, when the two drivers are caused to reciprocate in the opposite phases relative to each other according to the conventional technology, the rotational moments around the rotational shaft of the rotational motor caused to the respective drivers have the same direction. Thus, a great vibration is caused at the time of using the reciprocating electric shaver. Then, for reducing the rotational moments around the rotational shaft of the rotational motor, it is conceivable to adjust the balancer such that the gravity center of the driver portion approaches the rotational shaft of the rotational motor. In this case, however, the weight of the balancer is likely to be larger. This caused such a problem as that the balancer becomes larger to thereby enlarge the entire apparatus and increase the load weight of the driver portion such as rotational motor.

It is an object of the present invention to provide a reciprocating electric shaver capable of suppressing a vibration even when a plurality of drivers are provided in parallel and capable of reducing the load weight of the driver portion without enlarging the entire apparatus.

### Solution to Problem

According to one aspect of the present invention, there is provided a reciprocating electric shaver comprising: a pair of drive blocks each including: a driver for driving a blade; a balance adjusting portion interlocked with the driver, wherein the drivers of the pair of the drive blocks make reciprocating movements in opposite phases relative to each other, and with respect to an axis of moments attributable to the reciprocating movements of the drivers, the balance adjusting portions and the drivers in the respective drive blocks are positioned opposite to each other so as to suppress the moments.

### Advantageous Effects of Invention

Each of the drive blocks has the balance adjusting portion. With respect to an axis of a moment attributable to the reciprocating movements of the drivers, the balance adjusting portions are each positioned on a side opposite to a side of the driver included in one of the respective drive blocks. Thus, the gravity centers of the respective drive blocks are disposed closer to the shaft of the moment than when the balance adjusting portions are not provided. That is, the distance from the axis of the moment to the gravity centers of the respective drive blocks can be shortened, thus enabling to reduce the moment around the axis caused by the respective drivers.

### BRIEF DESCRIPTION OF DRAWINGS

FIG. 1 is a drawing showing a reciprocating electric shaver according to one embodiment of the present invention, where (a) is a front view, (b) is a side view and (c) is a back view.

FIG. 2 is an exploded perspective view showing a head portion according to the one embodiment of the present invention.

FIG. 3 is an exploded perspective view showing a blade frame portion according to the one embodiment of the present invention.

FIG. 4 is a perspective view of the head portion according to the one embodiment of the present invention.

FIG. 5 is a transverse cross sectional view of the head portion according to the one embodiment of the present invention.

FIG. 6 is a side sectional view of the head portion according to the one embodiment of the present invention.

FIG. 7 is a perspective view showing a drive mechanism according to the one embodiment of the present invention.

FIG. 8 is a perspective view showing the drive mechanism viewed from the side opposite to the side in FIG. 7 according to the one embodiment of the present invention.

FIG. 9 is a side view showing the drive mechanism according to the one embodiment of the present invention.

FIG. 10 is a side sectional view of the drive mechanism according to the one embodiment of the present invention.

FIG. 11 is a drawing showing the drive mechanism according to the one embodiment of the present invention, where (a) is a plan view and (b) is a plan view schematically showing the movement during vibration.

FIG. 12 is an exploded perspective view showing drivers and balance adjusting portions according to the one embodiment of the present invention.

FIG. 13 is an exploded perspective view showing the drivers and balance adjusting portions from the side opposite to the side in FIG. 12 according to the one embodiment of the present invention.

FIG. 14 is a drawing showing the first driver according to the one embodiment of the present invention, where (a) is a front view and (b) is a plan view.

FIG. 15 is a drawing showing the second driver according to the one embodiment of the present invention, where (a) is a front view and (b) is a plan view.

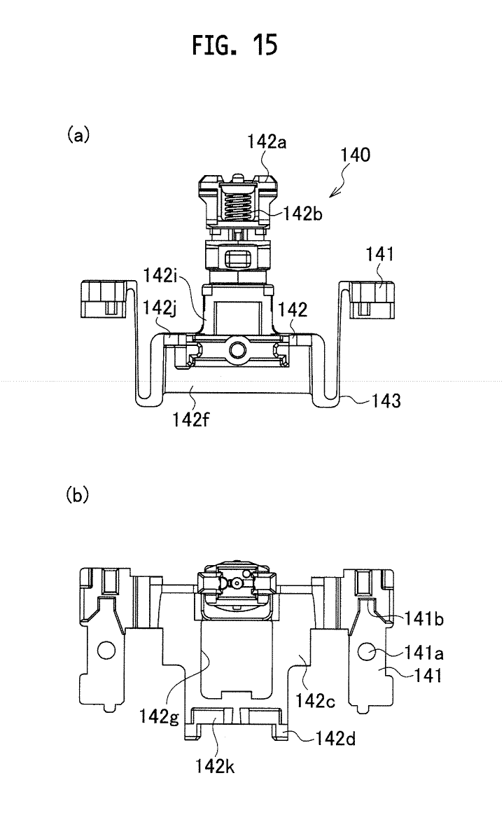

FIG. 16 is a side view showing the drive mechanism according to a first modified example of the one embodiment of the present invention.

FIG. 17 is a side view showing the drive mechanism according to a second modified example of the one embodiment of the present invention.

FIG. 18 is a perspective view showing a modified example of the first driver according to the one embodiment of the present invention.

### DESCRIPTION OF EMBODIMENTS

Hereinafter, one embodiment of the present invention will be explained in detail with reference to drawings. Herein, the forward-rearward direction (shaving direction) in which a plurality of outer blades are provided in parallel is defined as an X axis, the right-left direction in which each of the outer blades extends is defined as Y direction, and the upper-lower direction in a state with a head portion disposed so as to turn the outer blades upward is defined as Z direction. Further, the side provided with a switch portion of the reciprocating electric shaver is defined as front in the X direction.

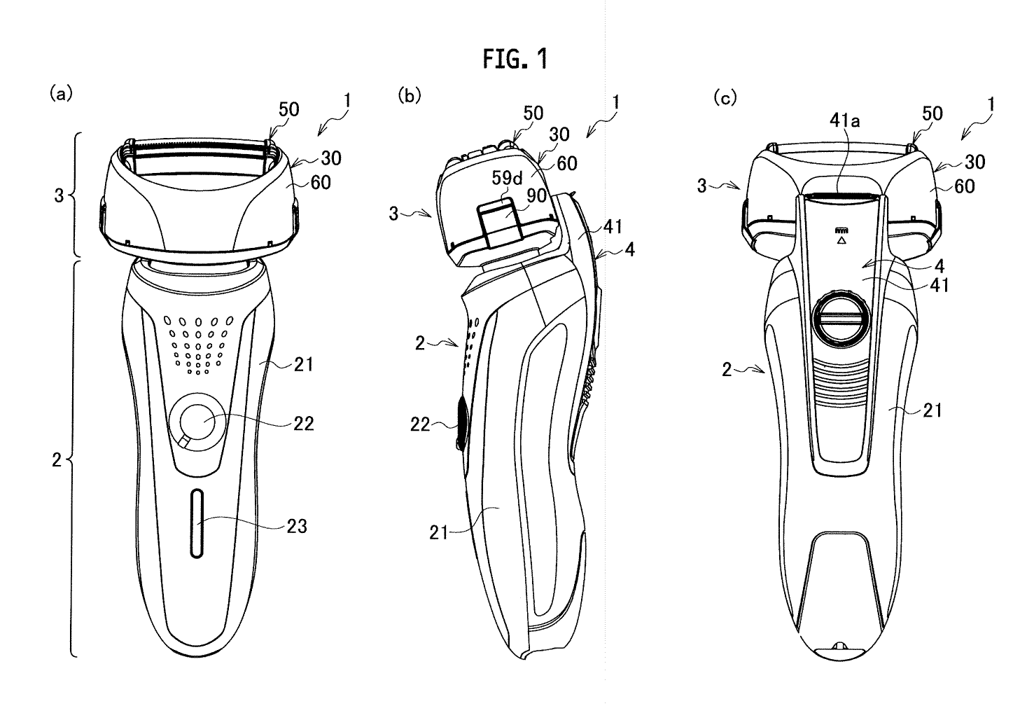

As shown in FIG. 1, the reciprocating electric shaver 1 according to the embodiment is provided with a grip portion 2 to be gripped by hand and a head portion 3 supported by the grip portion 2.

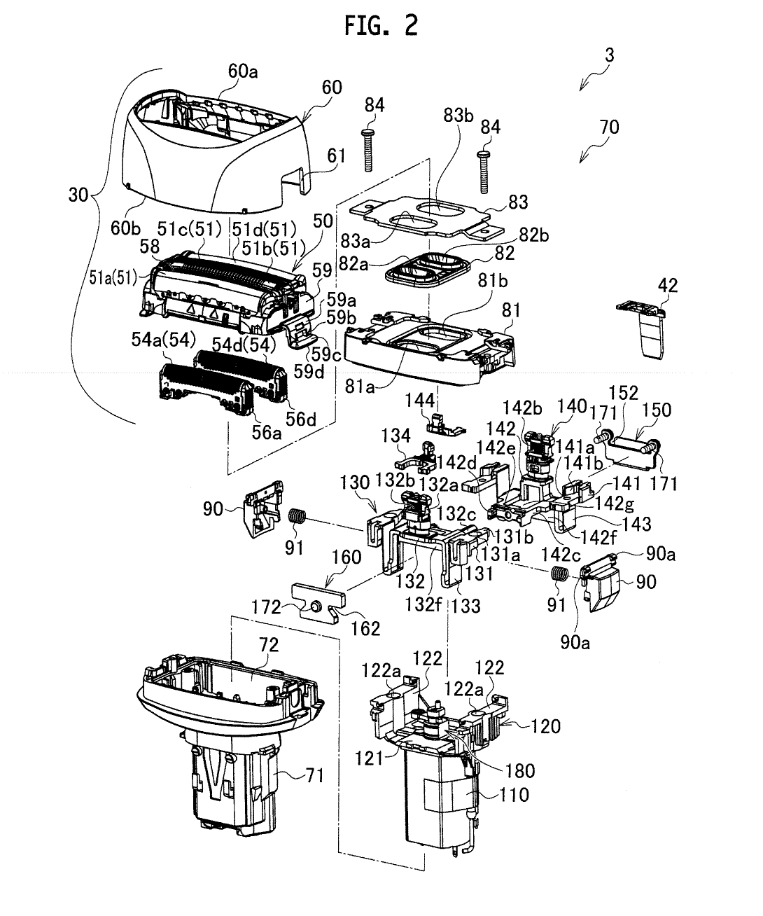

The grip portion 2 is provided with a grip portion body 21 made of synthetic resin. As shown in FIG. 1(a), the grip portion body 21 is formed with a switch portion 22 and a display portion 23. The switch portion 22 turns on and off the driving of a rotational motor 110 (refer to FIG. 2). The display portion 23 displays a charge state of a battery (not shown) incorporated in the grip portion body 21. Further, as shown in FIG. 1(c), the reciprocating electric shaver 1 according to the embodiment is provided with a trimmer unit 4. The trimmer unit 4 has a trimmer handle 41 mounted to a back side (rear side) of the grip portion body 21 so as to slide upward and downward and a trimmer blade 41a formed at an upper end of the trimmer handle 41.

An outer blade 51 exposed in an upward direction of the head portion 3 is mounted to the head portion 3. An inner blade 54 is disposed in the outer blade 51 (lower side of outer blade 51). The inner blade 54 makes a reciprocating movement along the Y direction relative to the outer blade 51. As a result, a hair inserted into a blade hole of the outer blade 51 is sheared by the outer blade 51 and inner blade 54.

Hereinafter, the structure of the head portion 3 will be explained.

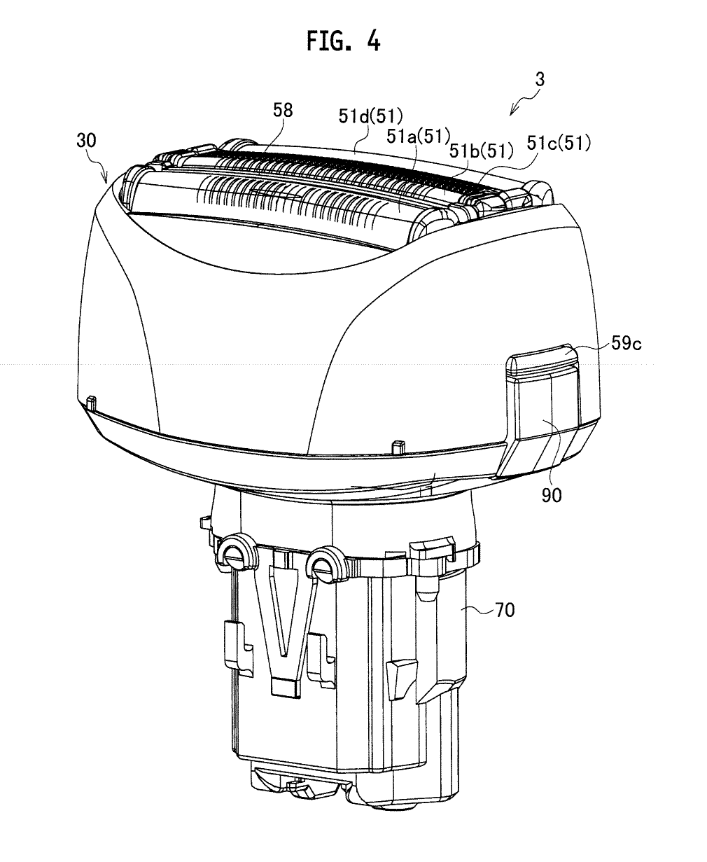

The head portion 3 is, as shown in FIG. 4, provided with a head portion body 70 and a blade frame portion 30. The head portion body 70 is mounted to the grip portion body 21. The blade frame portion 30 is detachably mounted to the head portion body 70.

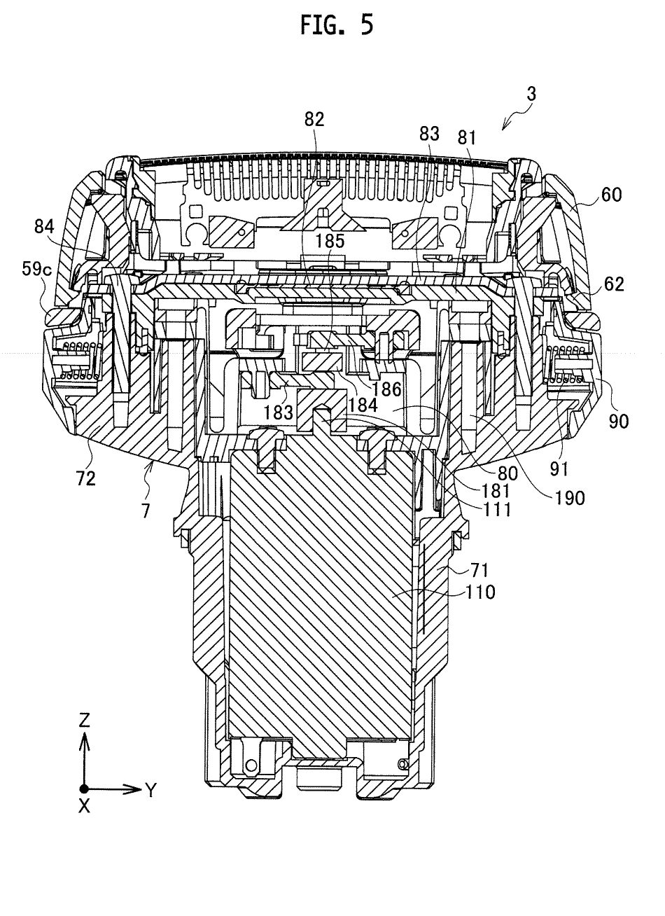

As shown in FIG. 5 to FIG. 8, the head portion body 70 according to the embodiment mainly includes a head case 71 and a drive mechanism 100. The head case 71 has a drive mechanism receiving portion 72 including an upper open portion opened upward. A part of the drive mechanism 100 is received in the drive mechanism receiving portion 72. In this state, as shown in FIG. 5, a head case cover 81 covers the upper open portion and, further, the head case cover 81 is fixed by a screw 84 via a driver waterproof rubber 82 and a rubber press plate 83.

Each portion of the drive mechanism 100, excepting a mounting portion to which the inner blade 54 is mounted, is received in the drive mechanism receiving portion 72. According to the embodiment, the mounting portion includes an inner blade mounting portion 132a of a first driver 130, an inner blade mounting portion 142a of a second driver 140, and drive rods 134, 144 respectively mounted to the inner blade mounting portions 132a, 142a. In other words, only the mounting portions of the drive mechanism 100 are exposed in an upper portion of the head portion body 70.

Specifically, first, the head case cover 81 is made to cover the upper open portion of the head case 71. Then, the inner blade mounting portions 132a, 142a of the first and second drivers 130, 140 are inserted from through holes 81a, 81b formed in the head case cover 81, to thereby expose the inner blade mounting portions 132a, 142a to the upper portion of the head case cover 81.

Then, the inner blade mounting portions 132a, 142a exposed upward are inserted from through holes 82a, 82b formed in the driver waterproof rubber 82 to thereby expose the inner blade mounting portions 132a, 142a to the upper portion of the driver waterproof rubber 82 (refer to FIG. 2). Then, neck portions of the inner blade mounting portions 132a, 142a press-contact the driver waterproof rubber 82. The pressing contact seals an inner space of the drive mechanism receiving portion 72.

Then, the inner blade mounting portions 132a, 142a exposed in an upper portion of the driver waterproof rubber 82 are inserted from through holes 83a, 83b formed in the rubber press plate 83 to thereby expose the inner blade mounting portions 132a, 142a in an upper portion of the rubber press plate 83 (refer to FIG. 2). Further, the drive rods 134, 144 are, respectively, mounted to the inner blade mounting portion 132a, 142a exposed in the upper portion of the rubber press plate 83. As a result, the drive mechanism 100 is received in the drive mechanism receiving portion 72 with only the mounting portions mounting the inner blade 54 exposed in the upper portion of the head portion body 70.

According to the embodiment, a substantially box-shaped water-proof space (seal space) 80 is formed by the head case 71, the head case cover 81, the driver waterproof rubber 82 and the rubber press plate 83 (refer to FIG. 5). Thus, entry of water used for removing hair shaved by the inner blade 54 or water for washing the inner blade 54 can be suppressed from entering into the waterproof space 80 receiving therein the rotational motor 110 and the like.

The blade frame portion 30 is, as shown in FIG. 2, provided with an outer blade cassette 50 formed into a box and a cylindrical outer peripheral frame 60 for receiving the outer blade cassette 50 from the lower side. The outer blade cassette 50 is provided with a plurality of outer blades 51 which are moveable upward and downward and is mounted in the cylindrical outer peripheral frame 60. The cylindrical outer peripheral frame 60 receiving therein the outer blade cassette 50 covers the entire periphery of the outer blade frame 59 of the outer blade cassette 50.

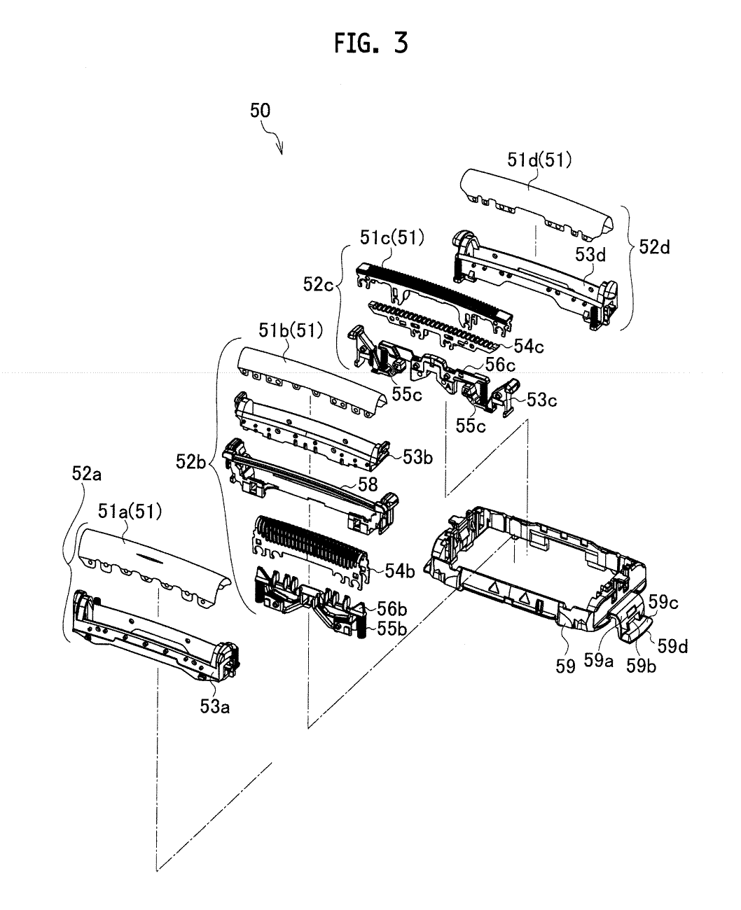

In the outer blade cassette 50, the plurality of outer blades 51 are provided in the X direction. Each of the outer blades 51 has a longitudinal direction parallel to the Y direction. According to the embodiment, four outer blades 51 are provided. That is, as each outer blade 51, a first net blade 51a, a finish net blade 51b, a slit blade 51c and a second net blade 51d are provided in the X direction (refer to FIG. 3).

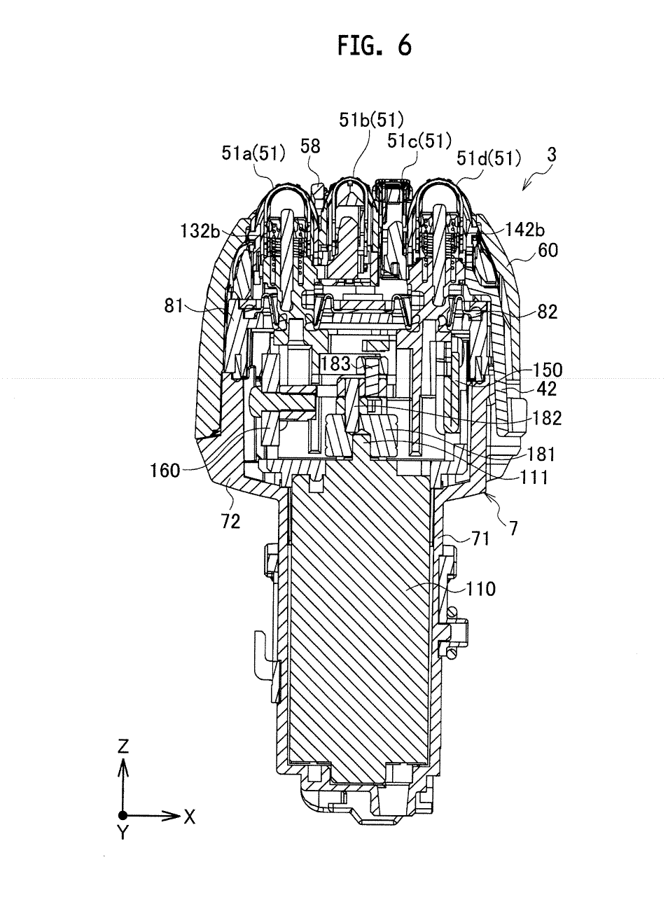

Each of the net blades 51a, 51b, 51d is, as shown in FIG. 6, formed in such a configuration as to be curved in a form of an inverted alphabetical U along the forward-backward direction (lateral direction) X such that an upper portion is protruded in a side view (a state in which the outer blade 51 is viewed in the Y direction). Further, the net blades 51a, 51b, 51d are formed in such a configuration as to be slightly curved along the right-left direction (longitudinal direction) Y such that the upper portion is protruded in the front view (a state in which the outer blade 51 is viewed in the X direction). Further, according to the embodiment, although the net blades 51a, 51b, 51d are curved such that the upper portion is protruded in the front view, the curving is not a must.

Then, many blade holes (not shown) are defined in the net blades 51a, 51b, 51d. Further, according to the embodiment, as shown in FIG. 6, it is formed such that the blade width of the finish net blade 51b (a width along the X axis) is smaller than the blade width of each of the net blades 51a, 51d (a width along the X axis). In this way, it is formed such that the blade width of the finish net blade 51b is smaller than the blade width of the other net blades 51a, 51d, that is, forming the curvature radius of the finish net blade 51b smaller can allow the skin pressed on the surface to protrude greatly inward from the blade hole, thus enabling to shave the hair short.

The slit blade 51c is, as shown in FIG. 3, formed into a curve so as to have a cross section in a form of a rectangular alphabetical U substantially perpendicular to the Y direction. In the slit blade 51c, many slits (blade holes) are defined along the X direction from a flat upper wall to a side wall.

That is, in the slit blade 51c, many slits (blade holes) are defined by a rectangular alphabetical U crosspiece extending from the flat upper wall to the side wall and a crosspiece extending along the right-left direction (longitudinal direction) Y below the side wall.

The net blades 51a, 51b, 51d and the slit blade 51c constituting the outer blade 51 are mounted to special outer blade frames 53a, 53b, 53d and 53c, respectively, thus forming the outer blade units 52a, 52b, 52d and 52c.

On the first net blade 51a side of the outer blade frame 53b, a skin guard member 58 is mounted. The slit blade 51c and the skin guard member 58 which sandwich the finish net blade 51b forward and backward effectively prevent the skin from being strongly pressed to the finish net blade 51b having the small curvature radius.

Then, the outer blade cassette 50 can be formed by engaging each of the outer blade units 52a, 52b, 52c and 52d with the outer blade frame 59 so as to independently move upward and downward. The outer blade cassette 50 is detachably mounted to the outer peripheral frame 60 and detachably mounted to the head portion body 70.

The inner blade 54 is provided with special blades for each of the net blades 51a, 51b, 51d and the slit blade 51c which constitute the outer blade 51. Specifically, in the lower portion (inside) of the net blades 51a, 51b, 51d, inner blades 54a, 54b, 54d each in a form of an inverted alphabetical U along the curve of one of the corresponding net blades 51a, 51b, 51d are provided (refer to FIG. 2 and FIG. 3). Then, below (inside) the slit blade 51c is provided a slit inner blade 54c in a form of a rectangular alphabetical U along the curve of the slit blade 51c.

The inner blades 54a, 54b, 54d and the slit inner blade 54c are mounted to the drive mechanism 100. Driving the drive mechanism 100 allows each of the inner blades 54a, 54b, 54d and the slit inner blade 54c to reciprocate along the right-left direction (longitudinal direction) Y.

In this way, moving the inner blades 54a, 54b, 54d and the slit inner blade 54c relative to the net blades 51a, 51b, 51d and the slit blade 51c, respectively, (reciprocating movement in the Y direction) allows the net blades 51a, 51b, 51d and the slit blade 51c to work in cooperation with the inner blades 54a, 54b, 54d and the slit inner blade 54c to cut (shear) the hair inserted into the blade hole of each of the net blades 51a, 51b, 51d and into the slit of the slit blade 51c.

Further, according to the embodiment, the finishing inner blade 54b is mounted to the outer blade cassette 50 so as to reciprocate relative to the finish net blade 51b with the finishing inner blade 54b mounted to a base 56b. Further, the slit inner blade 54c is mounted to the outer blade cassette 50 so as to reciprocate relative to the slit blade 51c with the slit inner blade 54c mounted to a base 56c (refer to FIG. 3).

With the outer blade unit 52c shown in FIG. 3, two outer blade frames 53c to which the slit blade 51c is mounted are disposed in the Y direction. The base 56c is positioned between the two outer blade frames 53c. The base 56c is disposed at the outer blade frame 53c via an inner blade pushup spring 55c. Thus, the base 56c freely reciprocates along the Y direction. The slit inner blade 54c is mounted to the base 56c. Further, the slit blade 51c is mounted to the outer blade frame 53c from an upper portion of the slit inner blade 54c such that the slit blade 51c covers the slit inner blade 54c.

With respect to the outer blade unit 52b shown in FIG. 3, the finish net blade 51b is mounted to the outer blade frame 53b, and the outer blade frame 53b is mounted to the skin guard member 58. On the other hand, the finishing inner blade 54b is mounted to the base 56b. The finishing inner blade 54b, in a state of being biased upward by the inner blade push up spring 55c, is disposed below the finish net blade 51b.

As set forth above, according to the embodiment, the inner blade mounting portions 132a, 142a are exposed in the upper portion of the head portion body 70 and the inner blades 54a, 54d are, respectively, mounted to the inner blade mounting portions 132a, 142a. With the drive rods 134, 144, respectively, mounted to the inner blade mounting portions 132a, 142a, the outer blade cassette 50 is mounted to the head portion body 70. The outer blade cassette 50 is mounted to the head portion body 70 in such a configuration as that the inner blades 54a, 54d are disposed in the space below the outer blade units 52a, 52d. When the outer blade cassette 50 is mounted to the head portion body 70, the bases 56b, 56c mounted to the outer blade cassette 50 are respectively connected to the drive rods 134, 144. That is, it is so configured that mounting the outer blade cassette 50 to the head portion body 70 allows the finishing inner blade 54b and the slit inner blade 54c to be interlocked with the movement of the drive mechanism 100.

As shown in FIG. 2, the outer blade frame 59 of the outer blade cassette 50 has a pair of elastic pieces 59a provided at right and left side portions of the outer blade frame 59. The elastic pieces 59a are so formed as to extend downward from the respective right side portion and left side portion of the outer blade frame 59. Each of the elastic pieces 59a is formed with a through hole 59b. The through hole 59b goes through the elastic piece 59a in the right-left direction. A release button 59c is provided at a lower end of each of the elastic pieces 59a. The release button 59c is formed so as to extend outward.

As shown in FIG. 2, an upper end of the cylindrical outer peripheral frame 60 is formed with an opening 60a and a lower portion of the cylindrical outer peripheral frame 60 is formed with an opening 60b. Further, a concave depressed portion 61 is formed at each of right and left side portions of the lower end edge of the outer peripheral frame 60. A hook 62 (refer to FIG. 5) protruding from the outer peripheral frame 60 inward is formed from a bottom portion of each of concave depressed portions 61.

According to the embodiment, the opening 60a is so formed as to be smaller than an outer configuration of the outer blade frame 59 of the outer blade cassette 50 and larger than an outer configuration of the entire blade face of the outer blade 51. Further, the opening 60b is so formed as to be larger than the outer blade frame 59's outer configuration excepting the release button 59c.

When the outer blade cassette 50 is inserted from the opening 60b into the outer peripheral frame 60 with the release buttons 59c at right and left ends passed through the concave depressed portion 61, the distal end portion of the hook 62 is engaged with the through hole 59b of each elastic piece 59a from outside (refer to FIG. 5). Thus, the outer blade frame 59, that is, the outer blade cassette 50 is mounted to the outer peripheral frame 60.

Further, the release button 59c of the outer blade frame 59 is, as shown in FIG. 4 and FIG. 5, so provided as to have a distal end of the release button 59c to protrude more outward than an outer face of the outer peripheral frame 60 when the outer peripheral frame 60 is mounted. Therefore, pressing the release buttons 59c inward in such a manner as to sandwich and grip the operation faces 59d at the distal ends of the right and left release buttons 59c sags the elastic pieces 59a on both sides inward to thereby disengage the hook 62 and the through hole 59 band release the mounting of the outer blade cassette 50 and the outer peripheral frame 60.

Further, at right and left ends of the head portion body 70, as shown in FIG. 5, release buttons 90 each biased outward along the Y direction by dint of a spring 91 are provided in such a configuration as to protrude and recede. Engagement protrusions 90a are provided at respective ends in the width direction (X direction) at an upper end portion of the release button 90 (refer to FIG. 2).

Then, when the blade frame portion 30 is made to cover the head portion body 70 from above with the release buttons 90 passed through the concave depressed portions 61 on right and left sides of the outer peripheral frame 60, the engagement protrusions 90a are engaged with an engaged concave portion (not shown) formed inside the outer blade frame 59, to thereby mount the outer blade frame 59 (the outer blade cassette 50 or the entirety of the blade frame portion 30) to the upper end of the head portion body 70.

Further, pressing the release button 90 inward against the biasing force of the spring 91 disengages the engagement of the engagement protrusions 90a and the engaged concave portion (not shown), to thereby disengage the mounting of the outer blade frame 59 and the head portion body 70.

Next, operations of the drive mechanism 100 will be explained.

According to the embodiment, the drive mechanism 100 is, as shown in FIG. 2, provided with the rotational motor 110, a support base 120 for supporting the rotational motor 110, the first and second drivers 130, 140 supported on the support base 120 and configured to make reciprocating movements in opposite phases relative to each other, and a conversion mechanism 180 for converting the rotational movement of the rotational motor 110 to a reciprocating movement to thereby transmit the reciprocating movement to the first and second drivers 130, 140.

The rotational motor 110 is mounted to the support base 120 in a hanging manner. The support base 120 is provided with a bottom wall portion 121 and fixed side wall portions 122 rising from right and left ends of the bottom wall portion 121 integrally with the bottom wall portion 121. The fixed side wall portion 122 is formed with a screw hole 122a. Screwing a fixing screw 190 into the screw hole 122a fixes the support base 120 together with the first and second drivers 130, 140 to the head case 71.

The conversion mechanism 180 is provided with a base 181 rotatably mounted to the rotational motor 110's rotational shaft 111 protruding from the bottom wall portion 121 of the support base 120 and a lower eccentric shaft 182 provided at the base 181 eccentrically from the rotational shaft 111. Further, the conversion mechanism 180 is provided with a lower connection arm 183 mounted to the lower eccentric shaft 182 and configured to connect the lower eccentric shaft 182 with the second driver 140 and a base 184 mounted to the lower eccentric shaft 182. Further, the conversion mechanism 180 is provided with an upper eccentric shaft 185 provided at the base 184 eccentrically from the rotational shaft 111 and an upper connection arm 186 mounted to the upper eccentric shaft 185 and configured to connect the upper eccentric shaft 185 with the first driver 130.

According to the embodiment, with a phase difference of 180° around the rotational shaft 111 of the rotational motor 110, the lower eccentric shaft 182 and the upper eccentric shaft 185 are provided at the base 184. Thus, the rotational movement of the rotational motor 110 is converted to the reciprocating movements of the opposite phases of the first driver 130 and second driver 140.

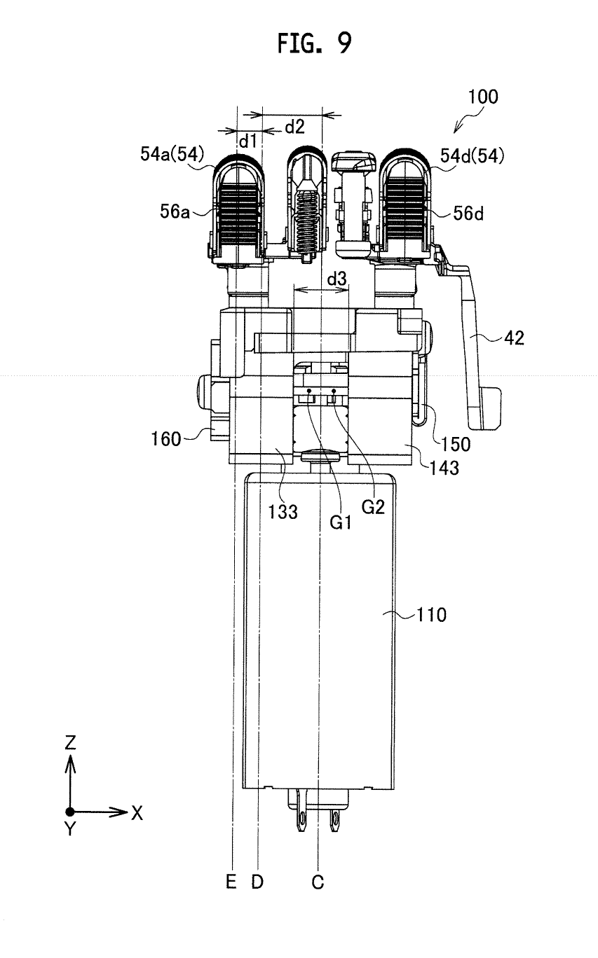

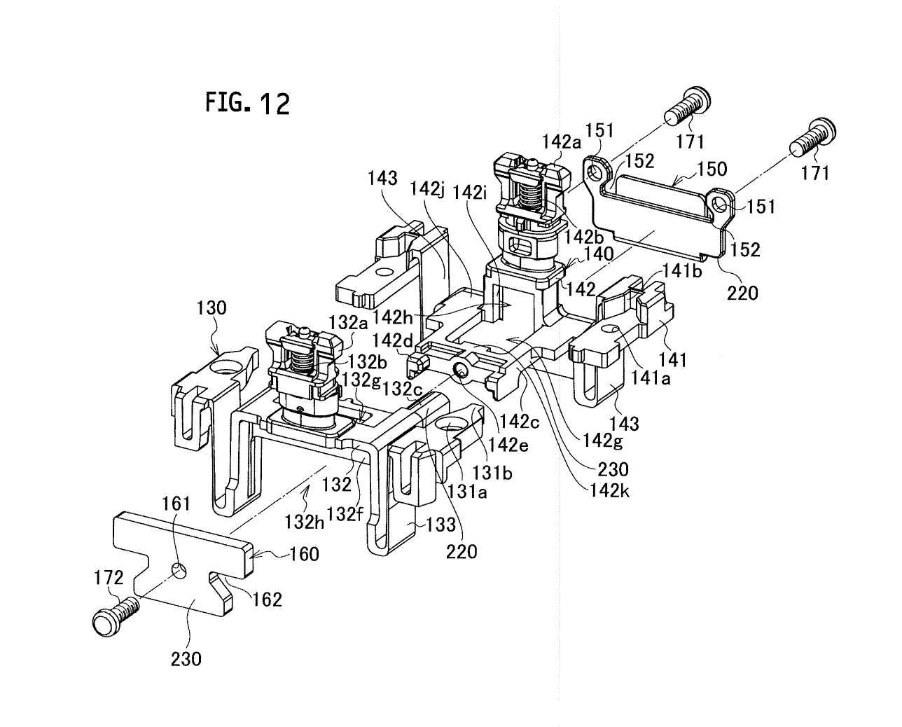

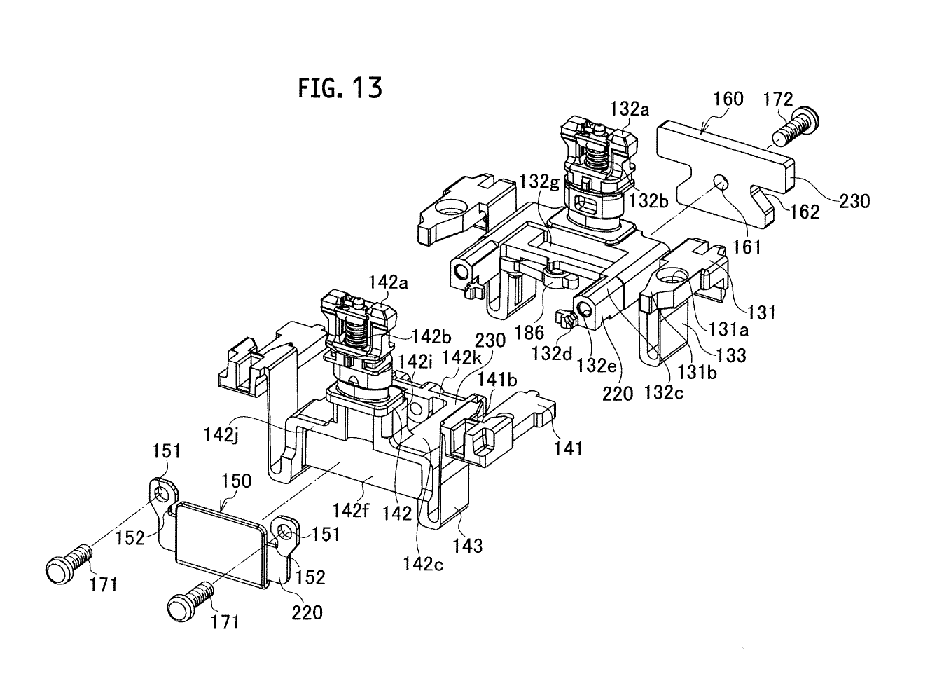

The first and second drivers 130, 140 are, as set forth above, provided with the inner blade mounting portions 132a, 142a, respectively. The inner blades 54a, 54d are detachably mounted to the inner blade mounting portions 132a, 142a, respectively. As shown in FIG. 12 and FIG. 13, the first driver 130 is provided with fixed blocks 131 disposed on respective ends in the width direction (Y direction in the assembled state), a support frame 132 disposed between the fixed blocks 131 and configured to support the inner blade mounting portion 132a, and a pair of elastic leg portions 133 for connecting the respective fixed blocks 131 with the support frame 132. The elastic leg portion 133 is elastically deformable and supports the inner blade mounting portion 132a reciprocably. Likewise, the second driver 140 is provided with fixed blocks 141 disposed on respective ends in the width direction (Y direction), a support frame 142 disposed between the fixed blocks 141 and configured to support the inner blade mounting portion 142a, and a pair of elastic leg portions 143 for connecting the respective fixed blocks 141 with the support frame 142. The elastic leg portion 143 is elastically deformable and supports the inner blade mounting portion 142a reciprocably. Further, the elastic leg portions 133, 143 are disposed to be positioned below the inner blade mounting portions 132a, 142a, respectively, when viewed from the right-left direction Y (refer to FIG. 9).

The fixed block 131 has a through hole 131a through which the fixing screw 190 (refer to FIG. 5) is inserted and an engaging convex portion (engaging portion) 131b. The fixed block 141 has a through hole 141a into which the fixing screw 190 is screwed and an engaged concave portion (engaged portion) engageable with the engaging convex portion 131b.

When the fixed block 131 is put above the fixed block 141 to thereby engage the engaging convex portion 131b with the engaged concave portion 141b, the through hole 131a communicates with the through hole 141a. With the through hole 131a communicated with the through hole 141a, the fixing screw 190 is inserted into the communication. A screw hole to be screwed with the fixing screw 190 is formed at the head case 71 and corresponds to the position of the through hole 131a and through hole 141a in the communicated state. Thus, the fixing screw 190 inserted into the through holes 131a, 141a is screwed with the screw hole. As a result, the first and second drivers 130, 140 are fixed to the head case 71 via the support base 120.

The support frames 132, 142 are each in a form of a rectangular plate extending substantially horizontally. The inner blade mounting portions 132a, 142a are protrudingly provided at upper portions of the support frames 132, 142, respectively. From respective ends in the width direction of the support frame 142, there are provided side wall portions 142i extending downward. Further, from a lower end of the side wall portion 142i, there is provided a horizontal wall portion 142j extending outward in the width direction (refer to FIG. 12).

The elastic leg portion 133 is formed like a band-shaped member folded in half, where one end of the elastic leg portion 133 is connected to an inside upper end of the fixed block 131 and the other end is connected to an outer end of the support frame 132. Likewise, the elastic leg portion 143 is formed like a band-shaped elastic member folded in half, where one end of the elastic leg portion 143 is connected to an inside upper end of the fixed block 141 and the other end is connected to an outer end of the horizontal wall portion 142j. That is, the elastic leg portion 143 connects the fixed block 141 with the support frame 142 via the horizontal wall portion 142j and the side wall portion 142i.

Further, the inner blade mounting portions 132a, 142a are provided with push up springs (biasing members) 132b, 142b, respectively. The push up spring 132b upwardly (detaching side in the attaching-detaching direction of the inner blade) presses (biases) the inner blade 54a mounted to the inner blade mounting portion 132a. The push up spring 142b upwardly (detaching side in the attaching-detaching direction of the inner blade) presses (biases) the inner blade 54d mounted to the inner blade mounting portion 142a.

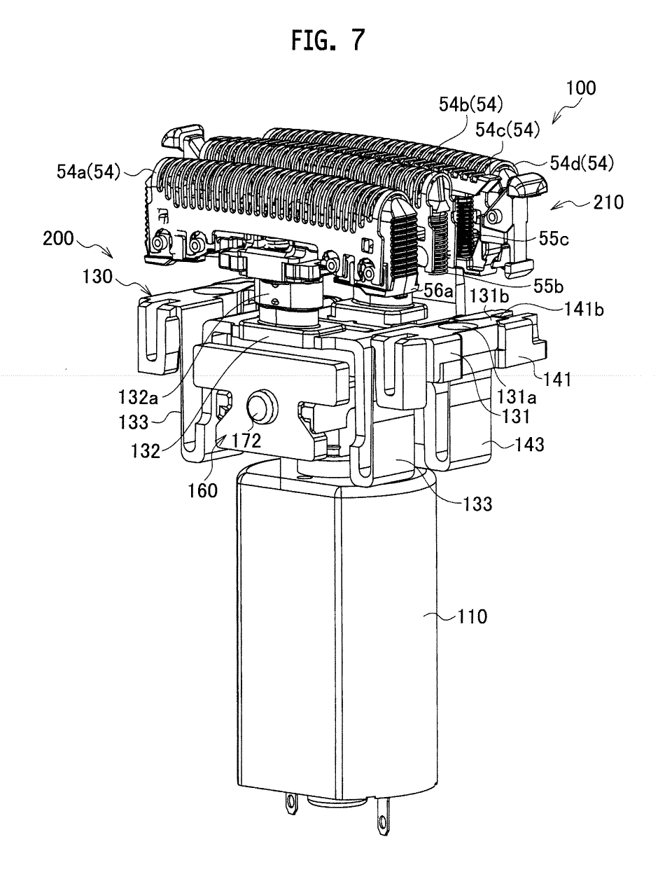

As shown in FIG. 7, in the elastic leg portions 133, 143 according to the embodiment, the outer band-shaped member is thinner than the inner band-shaped member. Since the outer band-shaped member is formed thinner, it is easy to swing the support frames 132, 142, the inner blade mounting portions 132a, 142a and the inner blade 54 in the Y direction. Further, the inner band-shaped member is likely to receive a reactive force from the inner blades 54a, 54d biased upward. Since the inner band-shaped member is formed thick, the first and second drivers 130, 140 can be suppressed from being deformed by the reactive force received from the inner blades 54a, 54d.

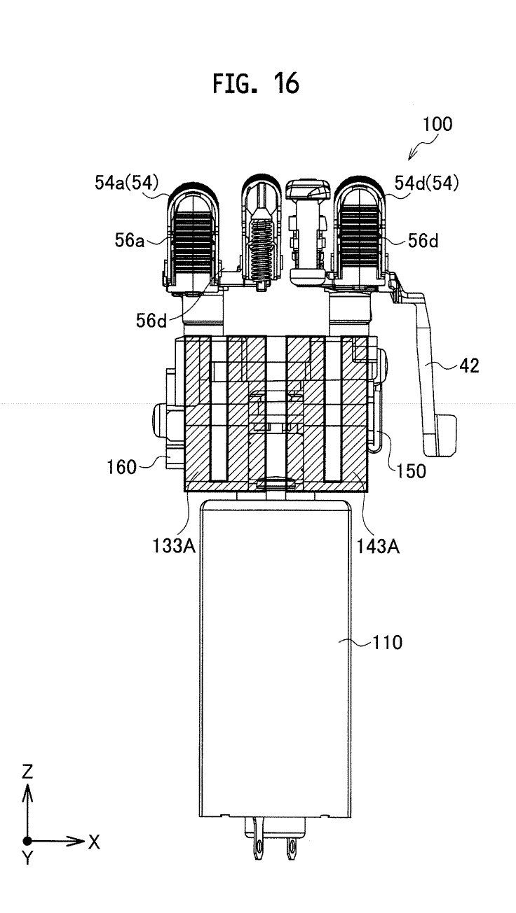

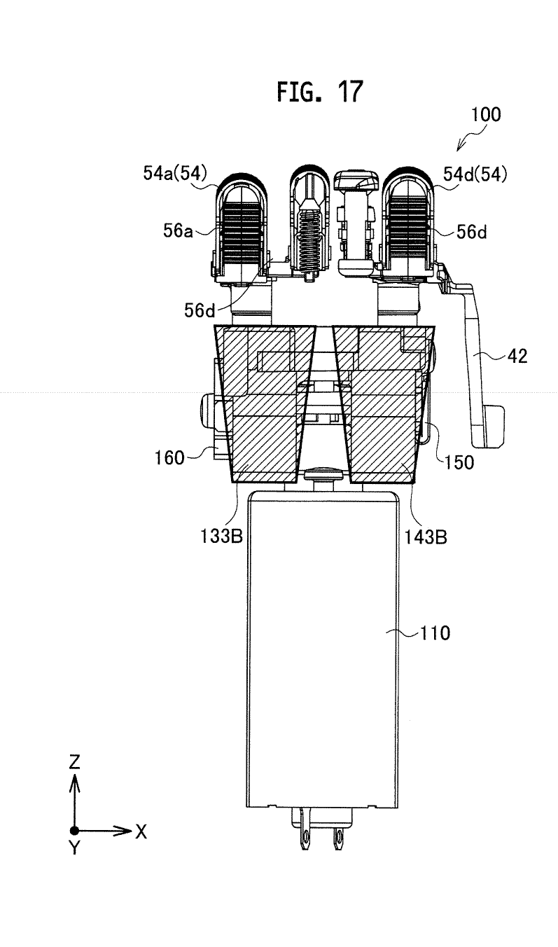

Further, the elastic leg portions set forth above may be formed in the configurations shown in FIG. 16 and FIG. 17.

That is, as shown in FIG. 16, providing a plurality of band-shaped elastic members in parallel in the X direction enables to form respective elastic leg portions 133A, 143A. In this case, it is preferable not to provide an elastic plate at a portion which is hardly influenced by the rotational moment in the X direction. In this case, the elastic leg portions 133A, 143A can be deformed with ease while enhancing rigidity of the elastic leg portions 133A, 143A by expanding the width of the elastic leg portions 133A, 143A. That is, this facilitates the reciprocating movement of the support frames 132, 142.

Further, it is possible to form elastic leg portions 133B, 143B as shown in FIG. 17. The elastic leg portions 133B, 143B include band-shaped elastic members each having an upper portion (inner blade side) formed into a flare with a wider width. In this structure, the elastic leg portions 133A, 143A can be suppressed as much as possible from being hardly deformed. Further, the rigidity can be enhanced at the upper portion which is greatly influenced by the rotational moment in the X direction.

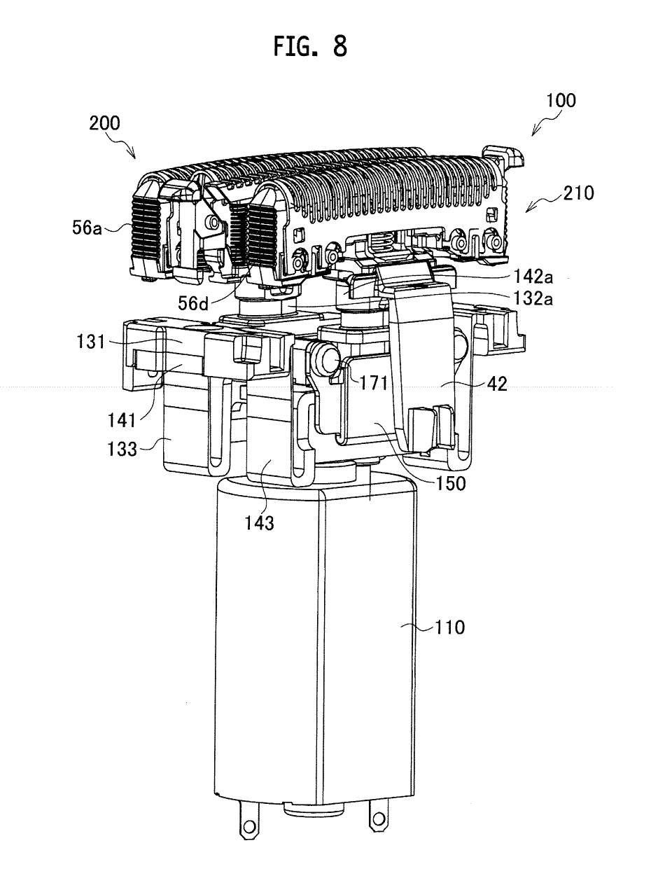

Further, according to the embodiment, a drive rod 42 is mounted to the inner blade mounting portion 142a (refer to FIGS. 8, 9). The drive rod 42 drives the trimmer blade 41a. Further, as set forth above, the drive rods 134, 144 are connected to the inner blade mounting portions 132a, 142, respectively. The finishing inner blade 54b is mounted to the drive rod 134. The slit inner blade 54c is mounted to the drive rod 144.

Thus, the first driver 130 allows the inner blade 54a and the finishing inner blade 54b to make an integrated reciprocating movement. The second driver 140 allows the inner blade 54d, the slit inner blade 54c and the drive rod 42 to make an integrated reciprocating movement.

That is, according to the embodiment, the inner blade (including the base 56a) 54a, the drive rod 134, the finishing inner blade (including the base 56b) 54b and a later-discussed balance adjusting member 150 serve as connection members connected to the first driver 130. The above connection members are interlocked with the reciprocating movement of the first driver 130. Then, the above connection members and the first driver 130 constitute a first drive block 200.

On the other hand, the inner blade (including the base 56d) 54d, the slit inner blade (including the base 56c) 54c, the drive rod 144, the drive rod 42, and a later-discussed balance adjusting member 160 serve as connection members connected to the second driver 140. The above connection members are interlocked with the reciprocating movement of the second driver 140. Then, the above connection members and the second driver 140 constitute a second drive block 210.

According to the embodiment, two inner blades 54 are disposed in each of the forward and rearward positions sandwiching therebetween a rotational axis line C of the rotational motor 110. The two forward inner blades and the two rearward inner blades make the reciprocating movements in opposite phases relative to each other. That is, the first driver 130 and the second driver 140 make the reciprocating movements in opposite phases relative to each other, thus reducing the vibration attributable to an inertial force (moment around the X axis) caused in the reciprocating direction (Y direction) of each of the drivers.

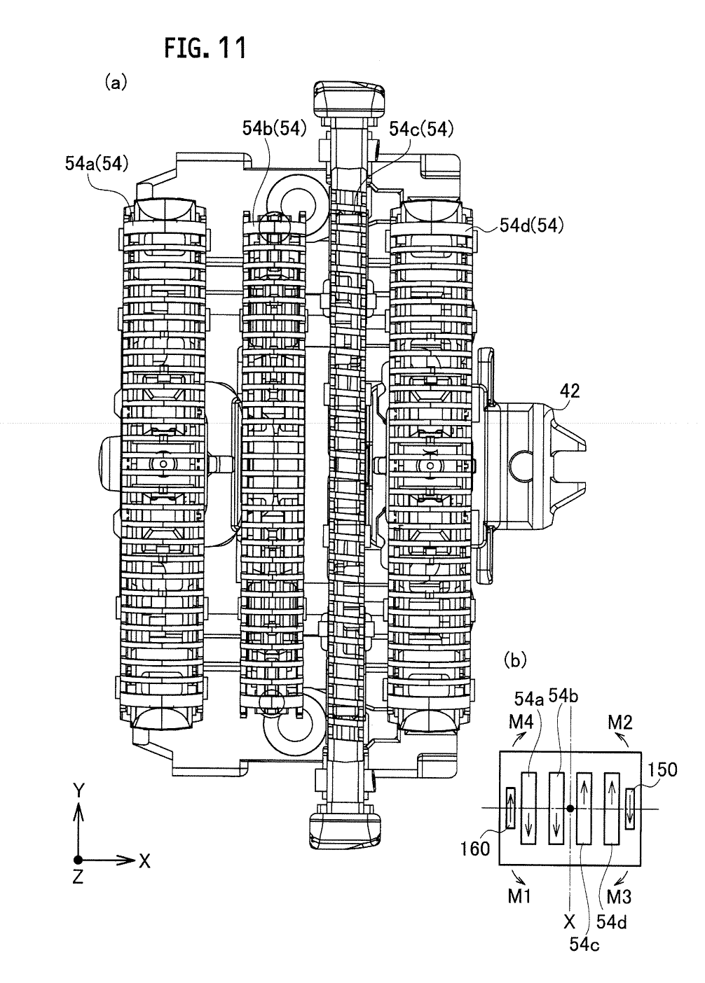

As set forth above, the two drivers' reciprocating movements in opposite phases can reduce the moments around the X axis. However, the reciprocating movements cause moments in the same direction around the rotational axis line C of the rotational motor 110 per half-cycle. For example, as shown in FIG. 11(b), the reciprocating movements of the opposite phases cause counterclockwise rotational forces M1, M2.

Then, according to the embodiment, the first drive block 200 has the balance adjusting portion (weight) 220 and the second drive block 210 has the balance adjusting portion (weight). The balance adjusting portion 220 is disposed on a side opposite to the first driver 130 with respect to the rotational axis line C of the rotational motor 110. Likewise, the balance adjusting portion 220 is disposed on a side opposite to the second driver 140 with respect to the rotational axis line C.

Specifically, as shown in FIG. 12 and FIG. 13, the balance adjusting member 150 is mounted to the first driver 130 via a holding arm 132c and the balance adjusting member 160 is mounted to the second driver 140 via a holding arm 142c.

As set forth above, the balance adjusting members 150, 160 are mounted to the first and second drivers 130, 140, respectively, to thereby allow gravity centers G1, G2 of the respective first and second drive blocks 200, 210 to be closer to the rotational axis line C of the rotational motor 110 than the gravity centers of the respective first and second drive blocks 200, 210 without the balance adjusting portions 220, 230, thus enabling to suppress the vibration around the rotational axis line C. Further, when the first and second drive blocks 200, 210 make the reciprocating movements in opposite phases relative to each other with the balance adjusting members 150, 160 mounted to the first and second drivers 130, 140, rotational forces M3, M4 are caused around the rotational axis line C by means of the balance adjusting members 150, 160 (refer to FIG. 11(b)). The directions of the moments by the rotational forces M3, M4 are opposite to the directions of the moments of the rotational forces M1, M2 caused around the rotational axis line C of the first and second drivers 130, 140. Thus, the rotational force M1 and the rotational force M3 are offset, and the rotational force M 2 and the rotational force M4 are offset, to thereby suppress the vibration around the rotational axis line C.

Further, the balance adjusting members 150, 160 are formed separately from the first and second drivers 130, 140, respectively.

Further, according to the embodiment, the balance adjusting portions 220, 230 are provided such that the gravity centers G1, G2 of the respective first and second drive blocks 200, 210 are positioned between the elastic leg portion 133 and the elastic leg portion 143 (in a range depicted by d3 in FIG. 9) when viewed from the right-left direction Y.

As a result, the gravity centers G1, G2 of the respective first and second drive blocks 200, 210 can be provided further closer to the rotational axis line C of the rotational motor 110. Thus, at the time of the driving, the moment caused around the rotational axis line C of the rotational motor 110 is further reduced, thus enabling to suppress the occurrence of the vibration.

Especially, designing the first and second drive blocks 200, 210 such that the gravity centers G1, G2 of the respective first and second drive blocks 200, 210 coincide with the rotational axis line C of the rotational motor 110 can zero the moment caused around the rotational axis line C of the rotational motor 110, thus enabling to further suppress the vibration occurrence.

Further, according to the embodiment, the balance adjusting member 150 is mounted to the holding arm (arm portion) 132c. The holding arm 132c extends from the first driver 130 to the side opposite to the first driver 130 with respect to the rotational axis line C of the rotational motor 110. Specifically, the holding arms 132c horizontally extend toward the opposing mating side (rearward in the X direction) from respective ends of the support frame 132 in the width direction (Y direction) of the support frame 132.

On the other hand, the balance adjusting member 160 is mounted to the holding arm (arm portion) 142c. The holding arm 142c extends from the second driver 140 to the side opposite to the second driver 140 with respect to the rotational axis line C of the rotational motor 110. Specifically, the holding arms 142c horizontally extend toward the opposing mating side (forward in the X direction) from respective ends of the horizontal wall portion 142j in the width direction (Y direction) of the horizontal wall portion 142j of the support frame 142.

In this way, the holding arm 132c extends from the first driver 130, and the holding arm 142c extends from the second driver 140. The holding arm 132c and the holding arm 142c extend along the X direction such that respective positions (heights) in the upward-downward Z direction are different. Further, as set forth above, the Z direction is defined as a direction perpendicular to the X direction on which the first and second drivers 130, 140 are provided in parallel and the Y direction in which the first and second drivers 130, 140 make the reciprocating movements. Disposing the holding arms in the X direction in the above manner contributes to miniaturize the first and second drive blocks 200, 210.

According to the embodiment, at least one of the holding arm 132c and the holding arm 142c is so positioned as to overlap with the conversion mechanism 180 in the Z direction. According to the embodiment, for example, the holding arm 142c is positioned so as to overlap with the conversion mechanism 180 in the Z direction. This positional overlap can further miniaturize (miniaturization in the height direction) the first and second drive blocks 200, 210.

Further, each of the holding arm 132c and holding arm 142c functions by itself as the balance adjusting portions 220, 230, respectively. In other words, the holding arm 132c and the holding arm 142c are respectively included in the balance adjusting portions 220, 230.

Thus, even in the case of providing the holding arms 132c, 142c at the first and second drivers 130, 140 without providing the balance adjusting members 150, 160, the gravity centers G1, G2 of the respective first and second drive blocks 200, 210 can be disposed closer to the rotational axis line C of the rotational motor 110 than the gravity centers of the first and second drive blocks in the case of having no balance adjusting portions 220, 230. That is, properly setting the length and weight of the holding arms 132c, 142c without providing the balance adjusting members 150, 160 can suppress the occurrence of the vibration.

Further, a screw hole 132e is formed in the distal end face of the holding arm 132c. The balance adjusting member 150 is formed with a mounting hole 151 in a position responding to the screw hole 132e. Thus, screwing a screw 171 into the screw hole 132e communicated with the mounting hole 151 of the balance adjusting member 150 fixes and retains the balance adjusting member 150 to the first driver 130. That is, the balance adjusting member 150 is mounted to the first driver 130 from the rearward position in the X direction in which the first and second drivers 130, 140 are provided in parallel.

Further, a connecting arm 142k for connecting the holding arms 142c with each other is provided at the front end portion of the holding arm 142c so that the connecting arm 142k extends in the Y direction. A screw hole 142e is formed in the central portion in the width direction of the connecting arm 142k. The balance adjusting member 160 is formed with amounting hole 161 in a position responding to the screw hole 142e. Thus, screwing a screw 172 into the screw hole 142e (of the second driver 140) communicated with the mounting hole 161 of the balance adjusting member 160 fixes and retains the balance adjusting member 160 to the second driver 140. That is, the balance adjusting member 160 is mounted to the second driver 140 from the forward position in the X direction in which the first and second drivers 130, 140 are provided in parallel.

In this way, the balance adjusting member 150 is mounted to the first driver 130 from the rear side (rear in the X direction) of the second driver 140, and the balance adjusting member 160 is mounted to the second driver 140 from the rear side (front in the X direction) of the first driver 130. The above mounting operations of the balance adjusting members 150, 160 can be accomplished even after the assembling of the first driver 130, second driver 140 and rotational motor 110, thus making it easy to mount the balance adjusting members 150, 160.

Further, the balance adjusting members 150, 160 are provided to be positioned in the outermost portions of the respective first and second drivers 130, 140 (respective ends of the entirety of the first and second drivers 130, 140 in the X direction). According to the embodiment, as shown in FIG. 9, the balance adjusting member 150 is provided at the first driver 130 such that at least a part of the balance adjusting member 150 protrudes from the side opposite, relative to the second driver 140, to the side for providing the first driver 130. Likewise, the balance adjusting member 160 is provided at the second driver 140 such that at least a part of the balance adjusting member 160 protrudes from the side opposite, relative to the first driver 130, to the side for providing the second driver 140. Thus, enlarging of the first and second drive blocks 200, 210 is suppressed, thus enabling to elongate as much as possible the distance of the balance adjusting members 150, 160 (in other words, the distance between the rotational axis line C and the gravity center). Further, the weight of the balance adjusting members 150, 160 can be reduced. Reducing the balance adjusting members 150, 160 in weight can further miniaturize the balance adjusting members 150, 160. Therefore, enlarging of the first and second drive blocks 200, 210 can be further suppressed.

Further, reducing of the weight of the balance adjusting members 150, 160 can reduce the load weight of the rotational motor 110 as well. Thus, the power consumption of the rotational motor 110 can be suppressed. This suppressing is beneficial for lengthening the operating time of the rechargeable electric shaver.

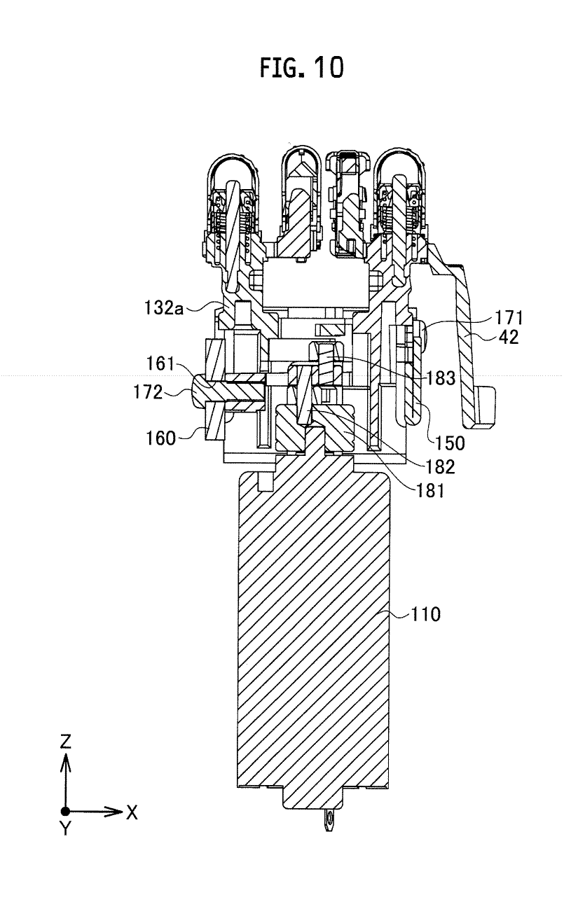

Further, as shown in FIG. 10, the other part of each of the balance adjusting members 150, 160 may be disposed inside the outermost part of one of the first and second drivers 130, 140 (both ends of the entirety of the first and second drivers 130, 140 in the X direction). In this case, the balance adjusting members 150, 160 can be suppressed from greatly protruding outside the first and second drivers 130, 140. Only the part of each of the balance adjusting members 150, 160 is disposed inside the first and second drivers 130, 140, thus enabling to suppress the position of the operation point (gravity center) of one of the balance adjusting members 150, 160 from being deviated inward.

Further, providing the balance adjusting members 150, 160 to be positioned in the outermost part of the first and second drivers 130, 140 can mount the balance adjusting members 150, 160 without restriction by the configuration of the first and second drivers 130, 140. Thus, the degree of freedom of configuration of the first and second drivers 130, 140 can be improved.

Further, according to the embodiment, the balance adjusting members 150, 160 are different in configuration so that the optimum gravity position can be secured for the first and second drive blocks 200, 210.

Specifically, the balance adjusting member 150 is formed by folding a plate-shaped member substantially in a form of alphabetical Y and is formed with the above mounting holes 151 at the upper portion on respective ends in the width direction.

On the other hand, the balance adjusting member 160 is a plate-shaped member substantially in a form of alphabetical T in front view and is formed with the above mounting hole 161 in substantially the central portion.

As set forth above, the mounting holes 151, 161 are different from each other in position in the height direction. Due to this, it is so designed that the balance adjusting members 150, 160 become the same in height position when the balance adjusting members 150, 160 are mounted to the first and second drivers 130, 140, thus contributing to miniaturize the first and second drive blocks 200, 210.

According to the embodiment, the balance adjusting members 150, 160 are mounted, respectively, to the first and second drivers 130, 140 such that the thickness direction of the balance adjusting members 150, 160 is parallel to the X direction. This suppresses dimensional increase of the balance adjusting members 150, 160 in the X direction while enabling to elongate as much as possible the distance of the operation points of the balance adjusting members 150, 160 (distance from the gravity center to the rotational axis line C). Thus, the miniaturization of the first and second drive blocks 200, 210 can be designed.

On each of right and left sides of the balance adjusting member 150, there is formed a cutout 152 as an engaged portion. The holding arm 132c of the first driver 130 is formed with a protrusion 132d. The protrusion 132d engages with the cutout 152 of the balance adjusting member 150.

On each of right and left sides of the balance adjusting member 160, there is formed a cutout 162 as an engaged portion. The holding arm 142c of the second driver 140 is formed with a protrusion 142d. The protrusion 142d engages with the cutout 162 of the balance adjusting member 160. The above engaging operations allow the balance adjusting members 150, 160 to be fixed to the respective first and second drivers 130, 140 in a state of being positioned so as not to move upward, downward, rightward and leftward.

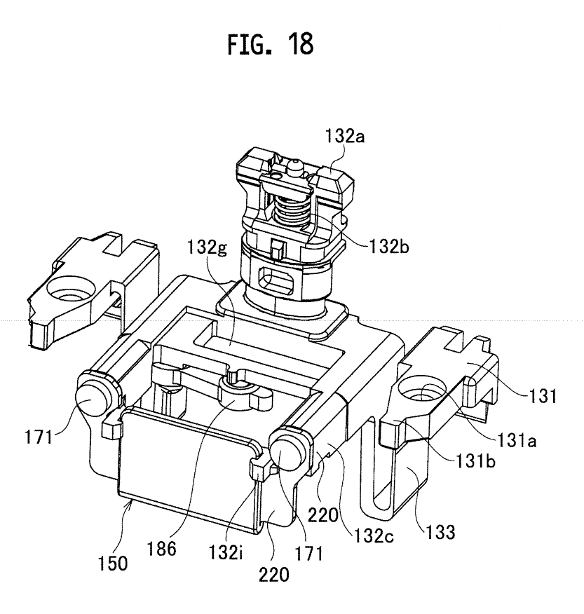

Further, as shown in FIG. 18, in place of the protrusion 132d, a hook portion (nail portion) 132i may be formed at the holding arm 132c. In this case, the hook portion 132i engages with the balance adjusting member 150. Further, the balance adjusting member may be heat-sealed to the driver. Further, in place of the cutout, a hole may be provided for engagement with the protrusion of the holding arm.

According to the embodiment, at least a part of the balance adjusting portion 220 provided at the first driver 130 is disposed in a space portion formed at the second driver 140. Specifically, a part of the holding arm 132c of the first driver 130 and a part of the balance adjusting member 150 are disposed in the space portion formed at the second driver 140. On the other hand, at least a part of the balance adjusting portion 230 provided at the second driver 140 is disposed in a space portion formed at the first driver 130. Specifically, a part of the holding arm 142c of the second driver 140 and a part of the balance adjusting member 160 are disposed in the space portion formed at the second driver 140. That is, at least a part of the member fixed to one driver is disposed in the space portion formed at the other driver. The above disposition prevents an interference between the holding arm 132c and the second driver 140 opposing the holding arm 132c. Likewise, an interference between the holding arm 142c and the first driver 130 opposing the holding arm 142c is prevented. Further, enlarging of the pair of first and second drivers 130, 140 is suppressed.

Specifically, a space is provided at a shoulder portion of the second driver 140 (namely, in an upper portion of the horizontal wall portion 142j), and the holding arm 132c of the first driver 130 passes through this space at the time of assembling the first and second drivers 130, 140. On the other hand, a space is also provided below the first driver 130, and the holding arm 142c of the second driver 140 passes through this space. Further, the space provided below the first driver 130 is the one formed between the pair of elastic leg portions 133 and corresponds to a later-discussed window portion 132h according to the embodiment.

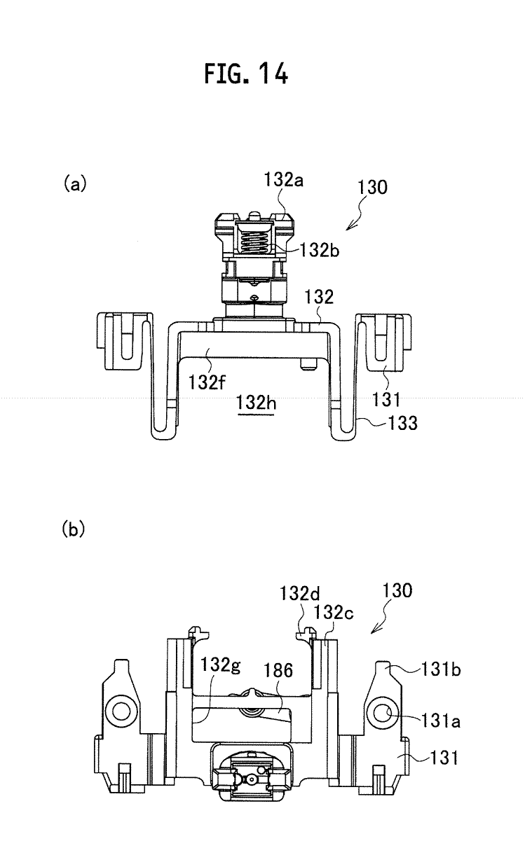

According to the embodiment, as shown in FIG. 14(a), the first driver 130 is provided with the window portion 132h through which the conversion mechanism 180 (refer to FIG. 2) is visible.

Specifically, the window portion 132h is formed by disposing the pair of elastic leg portions 133 and the support frame 132 in a substantially a gate form (rectangular alphabetical U). That is, the window portion 132h is surrounded in three directions thereof by the pair of elastic leg portions 133 and the support frame 132. Through the window portion 132h, the conversion mechanism 180 and the like are made visible from the X direction. Disposing the window portion 132h facilitates implementing the assembly work of the driver blocks as well as the verification work of the connection state of the conversion mechanism 180.

As shown in FIG. 13, in the first driver 130 according to the embodiment, the support frame 132 and the holding arm 132c form a window portion 132g. Through the window portion 132g, the conversion mechanism 180 and the like are made visible from the Z direction. Further, as shown in FIG. 12, in the second driver 140, the holding arm 142c and the connecting arm 142k form a window portion 142g. Through the window portion 142g, the conversion mechanism 180 and the like are made visible from the Z direction. In this way, visualizing the circumference of the conversion mechanism 180 can further facilitate implementing the assembly work and verification work.

According to the embodiment, the balance adjusting members 150, 160 are made of a material higher in density than that of the first and second drivers 130, 140. This material is, for example, a metal. Thus, the balance adjusting members 150, 160 can be further miniaturized. Further, the entirety of the head portion 3 can be miniaturized. According to the embodiment, as set forth above, the balance adjusting members 150, 160 are disposed in the waterproof space 80. Thus, corrosions such as rust of the balance adjusting members 150, 160 can be suppressed.

A center line D and an operation line E shown in FIG. 9, respectively, denote a central portion of the elastic leg portion 133 in the X direction and an operation direction of the reactive force caused by the push up spring 132b (refer to FIG. 12). In other words, the center line D denotes the central portion of the elastic leg portion 133 in the direction perpendicular to the reciprocating direction and attaching/detaching direction of the first driver 130. Further, the distance between the center line D and the operation line E in the X direction is defined as d1, and the distance between the center line D and the rotational axis line C of the rotational motor 110 in the X direction is defined as d2.

According to the embodiment, the elastic leg portion 133 is disposed such that the central portion of the elastic leg portion 133 in the X direction becomes closer to the operation line E than to the rotational axis line C. That is, the elastic leg portion 133 is so disposed as to meet d1<d2. The elastic leg portion 143 is disposed in a manner like that of the elastic leg portion 133. That is, the elastic leg portion 143 is disposed such that the central portion of the elastic leg portion 143 in the X direction becomes closer to the operation line of the reactive force caused by the push up spring 142b than to the rotational axis line C. The reactive forces by the push up springs 132b, 142b cause moments to the elastic leg portions 133, 143 around the Y axis. However, disposing the elastic leg portions 133, 143 as above can reduce the moments around the Y axis. Thus, the elastic leg portions 133, 143 can be suppressed from being broken by a concentrated stress. Further, disposing the elastic leg portions 133, 143 so as to be away from the rotational axis line C of the rotational motor 110 enlarges the moments (around the rotational axis line C) caused to the elastic leg portions 133, 143. However, according to the embodiment, since the reactive forces by the push up springs 132b, 142b are large, so disposing the elastic leg portions 133, 143 as to meet the relation d1<d2 can reduce the influence of the vibration given to the entire apparatus.

Further, as shown in FIG. 12 and FIG. 13, the first and second drivers 130, 140 are, respectively, formed with reinforcing wall portions 132f, 142f. According to the embodiment, the wall portion 132f is formed more inside than the operation line E of the reactive force by the push up spring 132b (rearward in the X direction), and the wall portion 142f is formed more inside than the operation line E of the reactive force by the push up spring 142b (forward in the X direction).

Providing the wall portions 132f, 142f causes moments around the Y axis. However, forming the wall portions 132f, 142f more inside than the operation line E of the reactive forces by the push up springs 132b, 142b can reduce the influence of the thus caused moments. Further, deformation of the first and second drivers 130, 140 by the reactive forces from the push up springs 132b, 142b can be suppressed.

Further, in the Z direction, the wall portion 132f is shorter than the elastic leg portion 133, thus preventing the window portion 132h from being blocked. However, the window portion 132h is blocked by mounting the balance adjusting member 160. This blocking can suppress a noise caused by the driver from leaking out.

As explained above, according to the embodiment, the first and second drive blocks 200, 210, respectively, have the balance adjusting portions 220, 230. The balance adjusting portions 220, 230 are each disposed on the side opposite to one of the respective first and second drivers 130, 140 with respect to the rotational axis line C of the rotational motor 110.

Thus, the gravity centers G1, G2 of the respective first and second drive blocks 200, 210 become closer to the rotational axis line C of the rotational motor 110 than when the balance adjusting portions 220, 230 are not provided. That is, the distance between the rotational axis line C of the rotational motor 110 to the gravity center of each of the drive blocks becomes shorter, thus reducing the moment around the rotational axis line C of the rotational motor 110 caused to each of the drivers. Thus, the vibration of the reciprocating electric shaver 1 with the plurality of drivers provided in parallel can be suppressed.

As set forth above, the preferred embodiment of the present invention has been explained. However, the present invention is not limited to the above embodiment and various modifications are permitted.

1. A reciprocating electric shaver comprising:
a pair of drive blocks each including:
a driver for driving a blade;
a balance adjusting portion interlocked with the driver,
wherein
the drivers of the pair of the drive blocks make reciprocating movements in opposite phases relative to each other, and
with respect to an axis of moments attributable to the reciprocating movements of the drivers, the balance adjusting portions and the drivers in the respective drive blocks are positioned opposite to each other so as to suppress the moments.

2. The reciprocating electric shaver according to claim 1 wherein
the balance adjusting portion connected to one of the drivers is provided such that at least a part of the balance adjusting portion protrudes from a side opposite, relative to the other of the drivers, to a side for providing the one of the drivers.

3. The reciprocating electric shaver according to claim 2 wherein
the balance adjusting portion has a balance adjusting member formed thin in a parallel direction of the drivers of the respective drive blocks.

4. The reciprocating electric shaver according to claim 1 wherein
the balance adjusting portion provided at one of the pair of the drive blocks is at least partially disposed at a space portion formed in the driver of the other of the pair of the drive blocks.

5. The reciprocating electric shaver according to claim 1 wherein
the balance adjusting portion is provided with an engaged portion to fix the balance adjusting portion to the driver.

6. The reciprocating electric shaver according to claim 1 wherein
the reciprocating movements of the drivers are parallel to each other.
